(19) United States
(12) Patent Application Publication
(10) Pub. No.: US 2019/0197576 A1
(43) Pub. Date: Jun. 27, 2019

(54) Electronic Rebate System And Method

(71) Applicant: Mastercard International Incorporated, Purchase, NY (US)

(72) Inventors: Navneet JAIN, Maharashtra (IN); Piyush SHARMA, Maharashtra (IN); Puneet GANDHI, Maharashtra (IN)

(73) Assignee: Mastercard International Incorporated, Purchase, NY (US)

(21) Appl. No.: 16/229,646

(22) Filed: Dec. 21, 2018

(30) Foreign Application Priority Data
Dec. 21, 2017 (SG) 10201710676W

(51) Int. Cl. G06Q 30/02; G06Q 20/12

(52) U.S. Cl. CPC G06Q 30/0234; G06Q 20/12

(57) ABSTRACT

The present disclosure generally relates to an electronic system, a computerized method, and a non-transitory computer-readable storage medium for a merchant to rebate customers. The system comprises a merchant server communicatively linked to a payment network. The merchant server is configured for performing steps of the method comprising: processing a number of customer transactions co-operatively with the payment network, each customer transaction performed between the merchant and a customer with a payment instrument of the customer; storing transaction data of the processed customer transactions on a merchant database; determining if the customers of the processed customer transactions are eligible for rebates based on past customer transactions performed by the customers with the merchant; identifying the processed customer transactions that are performed by the eligible customers; selecting one or more of the identified customer transactions; and performing a rebate transaction for each selected customer transaction for rebating the eligible customers thereof.

### CROSS-REFERENCE TO RELATED APPLICATIONS

This application claims priority to Singapore Patent Application No. 10201710676W filed on 21 Dec. 2017, which is hereby incorporated by reference in its entirety.

### TECHNICAL FIELD

The present disclosure generally relates to an electronic rebate system and method. Particularly, the present disclosure describes various embodiments of an electronic system and method for a merchant to rebate customers.

### BACKGROUND

Currently, when a customer enters a retail store or shop of a merchant and makes a purchase, the customer may pay for the purchase with a cashless payment instrument, such as a credit card. The customer performs a transaction with the merchant via a merchant billing machine or point-of-sale (POS) terminal. The POS terminal is communicatively linked to a payment network which processes the transaction, after which funds are transferred from the customer payment instrument to a financial account of the merchant.

In some situations, the merchant may find that a customer has been patronizing the retail shop for some time, transacting frequently with the merchant over a past period. The merchant may want to offer the customer user some form of incentive for his/her loyalty to the merchant. The merchant may offer an incentive to the customer, e.g. a discount off the items the customer is purchasing in the current transaction. However, this is a cumbersome manual process and is largely arbitrary on the part of the merchant. For example, on a good day when the merchant owner is around and recognizes the loyal customer, the merchant owner may decide to incentivize the loyal customer. But on some other days when the merchant owner is absent, none of the merchant staff recognizes the loyal customer and the loyal customer would not be able to receive any incentive from the merchant. The discretionary and arbitrary nature of the current incentivization process results in inconsistencies in incentivizing loyal customers, such as by discounts or rebates.

Therefore, in order to address or alleviate at least one of the aforementioned problems and/or disadvantages, there is a need to provide an electronic rebate system and method in which there is at least one improved feature.

### SUMMARY

According to a first aspect of the present disclosure, there is an electronic system, a computerized method, and a non-transitory computer-readable storage medium for a merchant to rebate customers. The system comprises a merchant server communicatively linked to a payment network. The merchant server is configured for performing steps of the method comprising: processing a number of customer transactions co-operatively with the payment network, each customer transaction performed between the merchant and a customer with a payment instrument of the customer; storing transaction data of the processed customer transactions on a merchant database; determining if the customers of the processed customer transactions are eligible for rebates based on past customer transactions performed by the customers with the merchant; identifying the processed customer transactions that are performed by the eligible customers; selecting one or more of the identified customer transactions; and performing a rebate transaction for each selected customer transaction for rebating the eligible customers thereof.

According to a second aspect of the present disclosure, there is an electronic system, a computerized method, and a non-transitory computer-readable storage medium for a merchant to rebate customers. The system comprises an intermediary transaction processor communicatively linked to a payment network. The intermediary transaction processor is configured for performing steps of the method comprising: receiving, from a merchant server, transaction data for a customer transaction performed between the merchant and a customer with a payment instrument of the customer; processing the customer transaction co-operatively with the payment network; determining if the customer is eligible for a rebate based on past customer transactions performed by the customer with the merchant; communicating, to the merchant server, rebate details associated with the customer transaction in response to determination that the customer is eligible; receiving, from the merchant server, a rebate message for approving or declining the rebate to the customer; and performing a rebate transaction for rebating the customer if the rebate message represents an approval of the rebate to the customer.

An electronic rebate system and method according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of an electronic system for a merchant to rebate customers, in accordance with embodiments of the present disclosure.

FIG. 2 is a flowchart illustration of a computerized method for a merchant to rebate customers, in accordance with embodiments of the present disclosure.

FIG. 3 is a flowchart illustration of a rebate transaction performed in the method of FIG. 2, in accordance with embodiments of the present disclosure.

FIG. 4A is another flowchart illustration of the method of FIG. 2, in accordance with some embodiments of the present disclosure.

FIG. 4B illustrates a table of data elements in transaction data, in accordance with some embodiments of the present disclosure.

FIG. 5 is another flowchart illustration of the method of FIG. 2, in accordance with some other embodiments of the present disclosure.

FIG. 6 is a flowchart illustration of another computerized method for a merchant to rebate customers, in accordance with embodiments of the present disclosure.

FIG. 7 is a block diagram illustration of the technical architecture of the merchant server of the electronic system of FIG. 1, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic rebate system and method, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

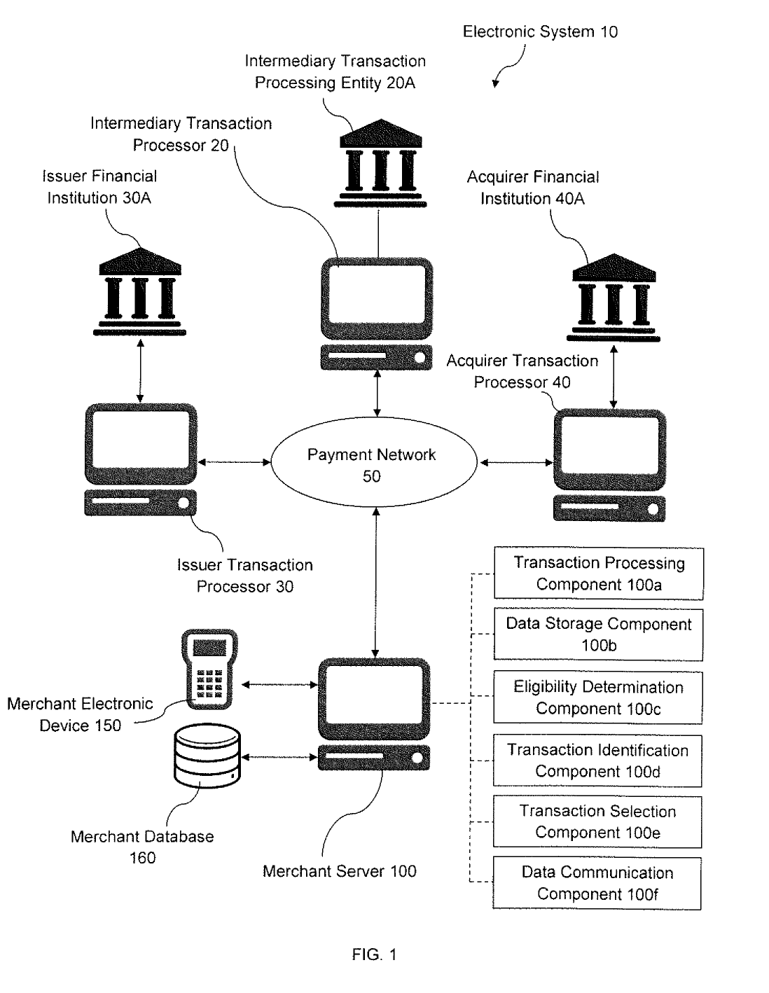

In representative or exemplary embodiments of the present disclosure, there is an electronic system 10 for a merchant to rebate customers, as illustrated in FIG. 1. The system 10 includes an intermediary transaction processor 20 operated by an intermediary transaction processing financial institution or entity 20A, one or more issuer transaction processors 30 operated by issuer financial institutions or banks 30A, and one or more acquirer transaction processors 40 operated by acquirer financial institutions or banks 40A. The system 10 further includes a payment network 50 communicatively connecting or linking the intermediary transaction processor 20, issuer transaction processors 30, and acquirer transaction processors 40 to one another. The payment network 50 is managed and operated by the intermediary transaction processing entity 20A, specifically a payment organization or payment card/credit card association, such as Mastercard® or Visa®.

The system 10 includes a server 100 and an electronic device 150 of the merchant which are communicatively linked or connected to each other. The merchant electronic device 150 may be a computing device, such as a merchant billing machine or point-of-sale (POS) terminal, which is located at a retail shop or store of the merchant. The merchant server 100 is communicatively linked or connected to the payment network 50 for processing transactions with customers at the merchant retail shop. It will be appreciated that these are electronic transactions that are processed electronically through the payment network 50.

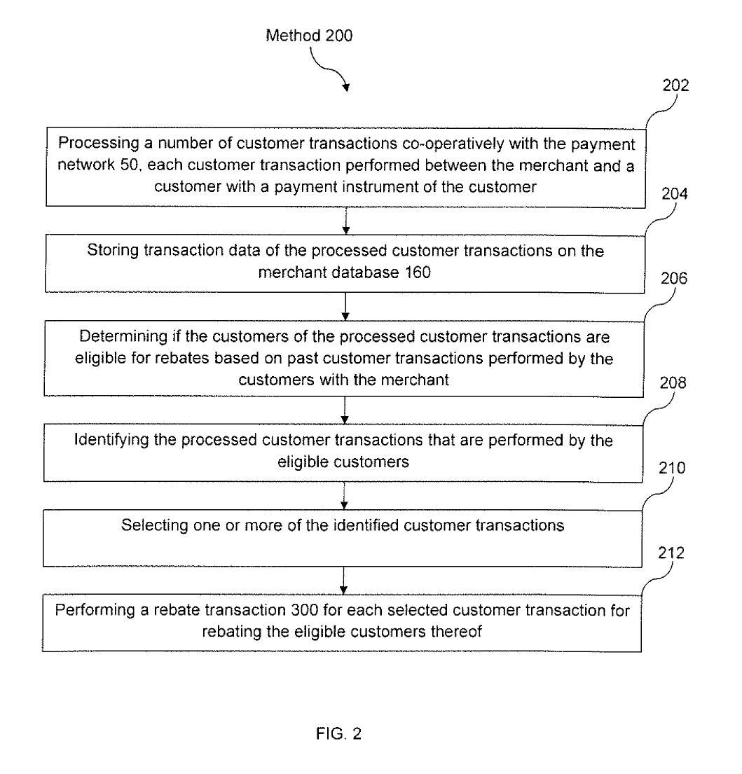

Further with reference to FIG. 2, there is shown a computer-implemented or computerized method 200 implemented on the merchant server 100. A merchant customer relation management (CRM) software application is operative on the merchant server 100 to perform the method 200. In many embodiments, when a customer visits the merchant retail shop to purchase items, the customer performs a customer transaction with the merchant. In a step 202 of the method 200, a transaction processing component/module 100a of the merchant server 100 processes a number of customer transactions co-operatively with the payment network 50, each customer transaction performed between the merchant and a customer with a payment instrument of the customer.

The processing of the customer transactions involves various entities linked to the payment network 50, including the issuer transaction processor 30, acquirer transaction processor 40, and intermediary transaction processor 20. More specifically, the intermediary transaction processor 20 facilitates communication between the issuer transaction processor 30 (operated by issuer bank 30A) and acquirer transaction processor 40 (operated by acquirer bank 40A) across the payment network 50 in order to process the customer transactions. It will be appreciated by the skilled person that the processing of the customer transactions has various standard stages, such as authentication of the customer payment instruments and authorization and clearing of the customer transactions.

In a step 204, a data storage component/module 100b of the merchant server 100 stores transaction data of the processed customer transactions on a merchant database 160. For example, the customer transactions that have been processed for the day are stored on the merchant database 160. At the end of the day, e.g. at a predefined time, the transaction data for all the processed customer transactions for the day, i.e. the day's batch of customer transactions, are communicated to the payment network 50 for further processing. More specifically, the transaction data of the day's processed customer transactions are communicated as a batch to the payment network 50 for clearing.

In a step 206, an eligibility determination component/module 100c of the merchant server 100 determines if the customers of the processed customer transactions are eligible for rebates based on past customer transactions performed by the customers with the merchant. For example, a customer is eligible for rebate if he/she has performed at least a predefined number of transactions with the merchant over a predefined past period. Transaction data of the past customer transactions may be retrieved from the merchant database 160.

In a step 208, a transaction identification component/module 100d of the merchant server 100 identifies the processed customer transactions that are performed by the eligible customers. In a step 210, a transaction selection component/module 100e selects one or more of the identified customer transactions. In one example, the merchant uses the CRM software to choose and select the identified customer transactions so that the eligible customers thereof can receive the rebates. In a step 212, the transaction processing component/module 100a of the merchant server 100 performs a rebate transaction 300 for each selected customer transaction for rebating the eligible customers thereof. In one embodiment, each rebate transaction is performed after the respective customer transaction is processed and before another customer transaction is processed, i.e. multiple rebate transactions are performed individually in real time. In another embodiment, all the rebate transactions are performed after all the customer transactions are processed, i.e. the rebate transactions are performed in batch mode.

Advantageously, when a customer performs a transaction with the merchant, the merchant server 100 is able to automatically determine if the customer is eligible for rebate based on his/her past transactions with the merchant. If the customer is eligible, the particular customer transaction performed by the eligible customer is identified from the rest of the customer transactions. For example, in a batch of customer transactions that is ready to be communicated to the payment network 50 for clearing, the customer transactions which are performed by eligible customers are identified so that one or more of those can be selected for rebating the eligible customers. The method 200 thus provides a more automated way for the merchant to identify the eligible customers and rebate them automatically when they perform customer transactions with the merchant. The selection of customers to receive rebates is thus less discretionary and arbitrary, allowing the merchant to more appropriately rebate the eligible customers. For the customers, loyal customers who have been frequenting the merchant will be eligible to receive appropriate rebates from the merchant, thereby incentivizing the customers to prefer the merchant to others.

### DESCRIPTION OF EMBODIMENTS

In various embodiments of the present disclosure with reference to FIG. 1, each of the intermediary transaction processor 20, issuer transaction processor 30, acquirer transaction processor 40, and merchant server 100 includes a processor, a data storage device or memory configured to store computer-readable instructions for processing thereby, and a data communication component/module for communicating with one or more other data communication components and/or transaction processors/servers. For example, the merchant server 100 includes a data communication component/module 100f for communicating with the payment network 50. It will be appreciated that an issuer transaction processor 30 is operated by an issuer financial institution or bank 30A that issues payment instruments, e.g. credit cards, to customers. It will also be appreciated that a merchant has a financial account with an acquirer financial institution or bank 40A, which operates the acquirer transaction processor 40, in order to accept electronic payments for transactions. For example, the merchant may accept credit card payments via its merchant electronic device 150, such as a merchant billing machine or POS terminal. Alternatively, the merchant electronic device 150 may be a mobile device, such as mobile phones, smartphones, personal digital assistants (PDAs), tablets, laptops, and/or computers.

As used herein, the term “payment instrument” may refer to any suitable cashless payment mechanism, such as payment cards, credit cards, and debit cards. The term “payment card” may refer to a credit card, debit card, prepaid card, or charge card which the customer may use to pay for transactions with the merchant. In addition, payment instruments may include, but are not limited to, membership cards, promotional cards, frequent flyer cards, identification cards, gift cards, and/or any other payment cards that may hold payment card information and which may be stored electronically, such as on an electronic device of the customer. For example, one or more payment instruments may be linked to a digital wallet such that payments to the merchant are made from one of the linked payment instruments. The customer electronic device may be a mobile device, such as mobile phone, smartphone, personal digital assistant (PDA), tablet, laptop, or computer. The application may be hosted remotely on a computing system.

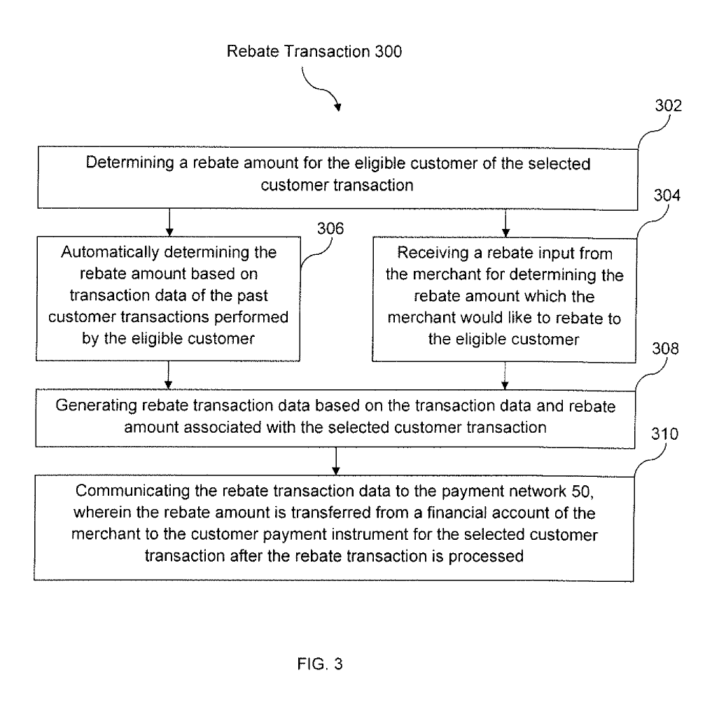

As described above, the method 200 is performed by the merchant server 100 to rebate customers of the merchant. Particularly, a merchant customer relation management (CRM) software application is operative on the merchant server 100 to perform the method 200. Loyal customers who have been frequenting the merchant are thus likely to be eligible for rebates. A rebate transaction 300 is performed for each selected, e.g. by the merchant, customer transaction that is performed by an eligible customer. Each rebate transaction 300 includes various steps as shown in FIG. 3.

Each rebate transaction 300 includes a step 302 of determining a rebate amount for the eligible customer of the selected customer transaction, wherein the selected customer transaction is performed with a particular customer payment instrument. In a step 304, the rebate amount may be automatically determined based on transaction data of the past customer transactions performed by the eligible customer with the merchant. The past customer transactions are identified as being performed by the eligible customer if the same payment instrument is used to transact the past customer transactions. For example, the payment instrument is a credit card and the customer transactions can be identified as being performed by the eligible customer based on the credit card number. As an example of determining the rebate amount, if the eligible customer has transacted an aggregated expenditure amount of $1,000 over the past 3 months, he/she may be eligible for a rebate amount of 1% of the aggregated amount. It will be appreciated that the conditions for automatic determination of the rebate amount may be adjusted by the merchant according to the merchant's preferred business model. Alternatively, the rebate amount may be determined based on the merchant's decision, such as by the merchant's owner or operator. The rebate transaction 300 may include a step 306 of receiving a rebate input from the merchant for determining the rebate amount which the merchant would like to rebate to the eligible customer. For example, if the eligible customer is performing a transaction worth $1,000 with the merchant, the merchant may arbitrarily enter a rebate input of $50 for the rebate amount to the eligible customer.

Each rebate transaction 300 further includes a step 308 of generating rebate transaction data based on the transaction data and rebate amount associated with the selected customer transaction. The rebate transaction data of the rebate transaction and the transaction data of the respective selected customer transaction may include common transaction reference data, such that the rebate transaction is matched or corresponded to the respective selected customer transaction. The common transaction reference data may include data elements that conform to the international standard for financial transaction card originated interchange messaging (ISO 8583). For example, some of these data elements include, but are not limited to, transmission date and time, system trace audit number (STAN), retrieval reference number (RRN), authorization identification response, original data elements, card identifier data elements to identify the customer payment instrument, and other private data elements to indicate the rebate transaction as being initiated by the merchant. The rebate transaction data also includes the rebate amount for the rebate transaction as a data element according to ISO 8583.

Each rebate transaction 300 further includes a step 310 of communicating the rebate transaction data to the payment network 50, wherein the rebate amount is transferred from a financial account of the merchant to the customer payment instrument for the selected customer transaction after the rebate transaction is processed. It will be appreciated that the processing of the rebate transaction is in part similar to the processing of a merchant chargeback or reversal transaction, wherein funds are debited from the merchant financial account and transferred to the customer payment instrument, after which a customer financial account linked to the customer payment instrument is credited with the funds. It will further be appreciated that such processing of transactions is standard and readily understood by the skilled person.

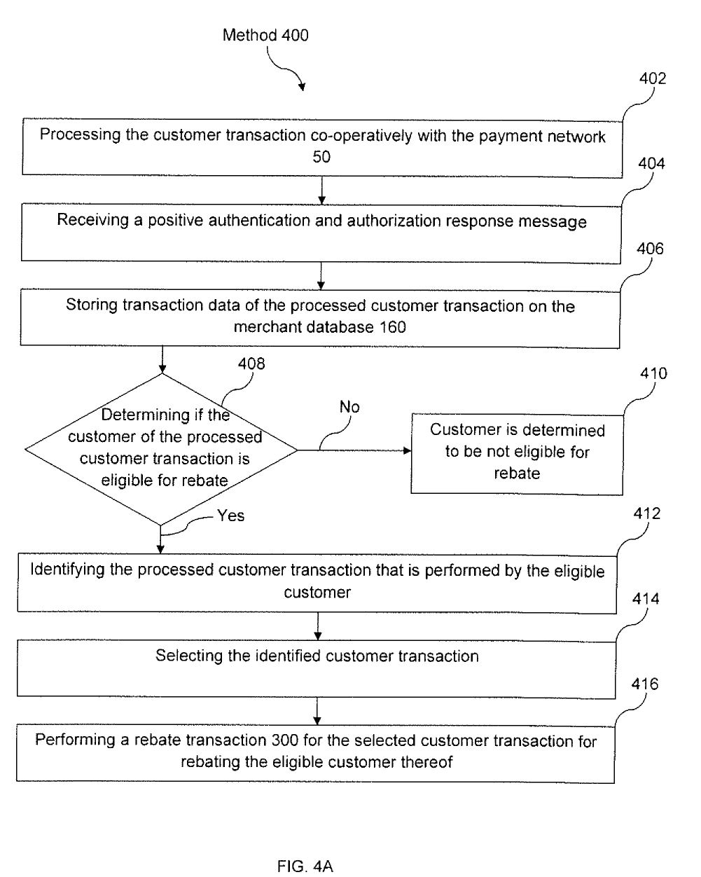

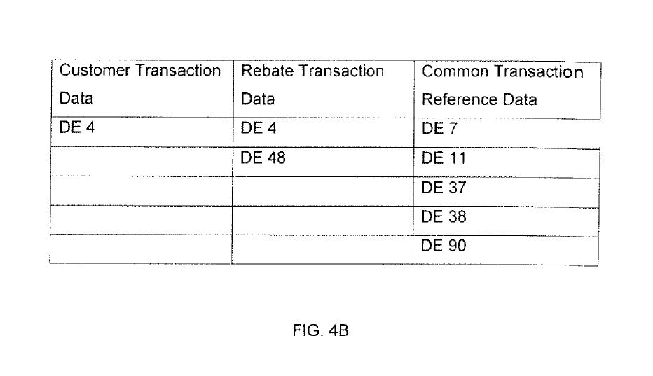

Some embodiments of the method 200 are described below as a method 400 with reference to FIG. 4A. Briefly, the method 400 involves one customer performing a transaction with the merchant, and the merchant performs the rebate transaction 300 after the customer transaction is processed.

When the customer visits the merchant retail shop to purchase items, the customer performs a customer transaction with the merchant. The customer provides the merchant with his/her payment instrument for payment of the purchased items, thereby performing the customer transaction with the customer payment instrument and through the merchant electronic device 150. In a step 402 of the method 400, the merchant server 100 processes the customer transaction co-operatively with the payment network 50. Particularly, the step 402 includes communicating the details of the customer transaction and customer payment instrument to the acquirer transaction processor 40 which is operated by an acquirer bank 40A. Notably, the merchant has a financial account with the acquirer bank 40A. The acquirer transaction processor 40 then communicates, to the intermediary transaction processor 20, a request for authentication of the customer payment instrument and authorization of the customer transaction. The intermediary transaction processor 20 then communicates the request to the issuer transaction processor 30 which is operated by an issuer bank 30A. Notably, the issuer bank 30A issued the customer payment instrument to the customer.

In a step 404, the merchant server 100 receives a positive authentication and authorization response message, indicating that the customer transaction is successfully processed. However, payment from the customer payment instrument to the merchant financial account is not completed until transaction data of the processed customer transaction is submitted to the acquirer transaction processor 40 for clearing. Clearing is a transaction stage through which the issuer transaction processor 30 exchanges the transaction data with the acquirer transaction processor 40 via the payment network 50. The clearing stage occurs simultaneously with the settlement stage, as will be readily understood by the skilled person. Generally, the transaction data of the processed customer transactions is communicated to the acquirer transaction processor 40 at predefined intervals or at a fixed predefined time daily, usually at the end of the business day. The predefined intervals or predefined time may be configured by the merchant on the merchant server 100 and/or merchant electronic device 150.

In a step 406, the merchant server 100 stores transaction data of the processed customer transaction on the merchant database 160 for subsequent communication to the payment network 50 for clearing of the processed customer transaction. The transaction data is representative of a record of the processed customer transaction and is stored on the merchant database 160 as an electronic draft capture (EDC).

In a step 408, after the customer has performed the transaction with the merchant, the merchant server 100 determines if the customer of the processed customer transaction is eligible for rebate based on past customer transactions performed by the customer with the merchant. The step 408 may include automatically identifying the customer as an eligible customer if transaction data of the past customer transactions satisfy predefined eligibility conditions. The predefined eligibility conditions may relate to frequency of transactions with the merchant and/or aggregated expenditure amount with the merchant. More specifically, the predefined eligibility conditions define a customer as being eligible for rebates if (i) he/she has performed at least a predefined number of transactions with the merchant over a predefined past period; and/or (ii) he/she has transacted at least a predefined aggregated expenditure amount with the merchant over a predefined past period. In one example, the customer is eligible if he/she has at least 10 past customer transactions with the merchant in the past 3 months, regardless of the aggregated expenditure amount. In another example, the customer is eligible if he/she has transacted an aggregated expenditure amount of at least $1,000 with the merchant in the past 3 months, regardless of the number of past customer transactions. In another example, the customer is eligible if he/she has at least 10 past customer transactions with the merchant and has transacted an aggregated expenditure amount of at least $1,000 in these 10 transactions. It will be appreciated that the predefined eligibility conditions may be adjusted by the merchant according to the merchant's preferred business model.

If the transaction data of the past customer transactions performed by the customer do not satisfy the predefined eligibility conditions, the step 408 proceeds to a step 410 wherein the customer is determined to be not eligible for rebate. However, the merchant CRM software may allow the merchant to have the discretion to bypass this determination and consider him/her to be eligible for rebate. Conversely, if the transaction data of the past customer transactions performed by the customer satisfy the predefined eligibility conditions, the step 408 proceeds to a step 412 wherein the merchant server 100 identifies the processed customer transaction that is performed by the eligible customer. Notably, the identified customer transaction is the one that was processed in the step 402.

In a step 414, the merchant server 100 selects the identified customer transaction for rebating the eligible customer thereof. In one embodiment, the identified customer transaction is automatically selected if the transaction data of the past customer transactions performed by the eligible customer satisfy predefined selection conditions. Similar to the predefined eligibility conditions, the predefined selection conditions may relate to frequency of transactions with the merchant and/or aggregated expenditure amount with the merchant. Further, the predefined selection conditions may be set to be more stringent than the predefined eligibility conditions, such that not all eligible customers are selected to receive rebates. In one example following the above examples regarding the predefined eligibility conditions, the identified customer transaction is selected if the customer has at least 15 past customer transactions with the merchant in the past 3 months, regardless of the aggregated expenditure amount. In another example, the identified customer transaction is selected if the customer has transacted an aggregated expenditure amount of at least $1,500 with the merchant in the past 3 months, regardless of the number of past customer transactions. In another example, the identified customer transaction is selected if the customer has at least 15 past customer transactions with the merchant and has transacted an aggregated expenditure amount of at least $1,500 in these 15 transactions. The predefined selection conditions may further include requiring that the customer has not received any rebate form the merchant over a predefined past period. It will be appreciated that the predefined selection conditions may be adjusted by the merchant according to the merchant's preferred business model.

If the predefined selection conditions are not satisfied, the identified customer transaction is not automatically selected and the customer will not receive any rebate, even though he/she is eligible. However, the merchant CRM software may allow the merchant to have the discretion to bypass this and still select the identified customer transaction so that the eligible customer can receive a rebate. In another embodiment, selecting the identified customer transaction is not automatic but instead manually done by the merchant. Specifically, the step 414 may include receiving a selection input from the merchant for selecting the identified customer transaction.

In a step 416, the merchant server 100 performs a rebate transaction 300 for the selected customer transaction for rebating the eligible customer thereof. As described above, the rebate transaction 300 includes determining the rebate amount and generating rebate transaction data based on the transaction data and rebate amount. In some embodiments, the rebate transaction 300 is performed immediately after the respective customer transaction is processed and before another customer transaction is processed, i.e. multiple rebate transactions 300 are performed individually in real time. The rebate transaction data may be aggregated with the transaction data of the processed customer transaction and collectively communicated to the payment network 50. Specifically, in the step 406, the transaction data of the processed customer transaction is stored on the merchant database 160 for subsequent communication to the payment network 50 for clearing of the processed customer transaction. The step 416 may include storing the rebate transaction data on the merchant database 160, specifically together with the transaction data of the processed customer transaction in the same batch of files. The batch of files is subsequently communicated to the payment network 50, such that the rebate transaction 300 and processed customer transaction are cleared and settled in the same batch, after which funds are transferred from the merchant to the customer.

In some embodiments, the data elements in the customer transaction data and rebate transaction data, as well as the common transaction reference data between them, are tabulated as shown in FIG. 4B. The data elements in the table are in accordance with ISO 8583.

The data elements in the common transaction reference data include, but may not be limited to, DE 7, DE 11, DE 37, DE 38, and DE 90. DE 7 refers to transmission date and time to facilitate matching of the rebate transaction with the customer transaction. DE 11 refers to STAN which is a unique identifier for the customer transaction to facilitate matching of the rebate transaction with the customer transaction. DE 37 refers to RRN which is a unique identifier for the merchant. DE 38 refers to the authorization identification response representing authorization of the customer payment instrument. DE 90 refers to the original data elements from the customer transaction data. In addition to the common data elements, the data elements in the customer transaction data and rebate transaction data include, but may not be limited to, DE 4. DE 4 refers to the transaction amount for the customer transaction or rebate amount for the rebate transaction. The rebate transaction data further include a data element DE 48 which is a private data element indicating that the rebate transaction is initiated by the merchant.

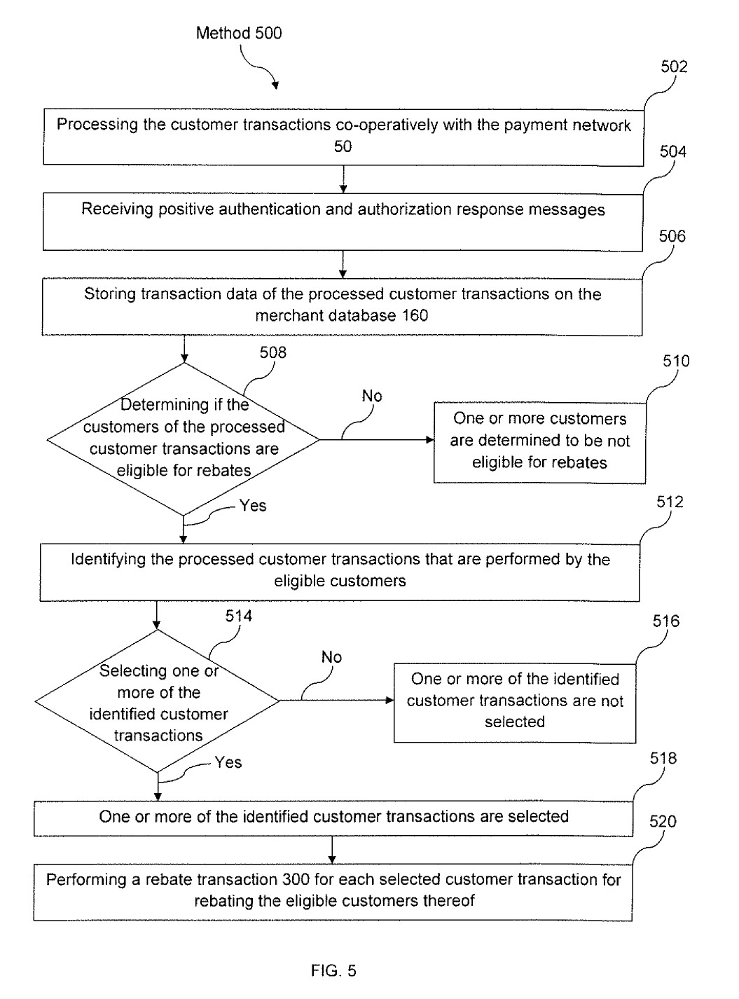

The method 400 involves the merchant performing the rebate transaction 300 after the customer transaction is processed. If there are several customers in queue and all of whom are eligible and selectable for rebates, there may be unnecessary waiting time for such loyal customers, potentially spoiling their consumer experience with the merchant. Some embodiments of the method 200 are described below as a method 500 with reference to FIG. 5. Briefly, the method 500 involves multiple customers performing transactions with the merchant, and the merchant performs one or more rebate transactions 300 after all the customer transactions are processed. For purpose of brevity, various aspects of the method 500 are analogous to that of the method 400 and are omitted in the following description of the method 500.

In a step 502 of the method 500, the merchant server 100 processes the customer transactions co-operatively with the payment network 50, each customer transaction performed between the merchant and a customer with a payment instrument of the customer. Notably, the customer transactions are processed over a time period, without the merchant performing any rebate transaction 300 in between. In a step 504, the merchant server 100 receives positive authentication and authorization response messages, indicating that the customer transactions are successfully processed. However, payments from the customer payment instruments to the merchant financial account are not completed until transaction data of the processed customer transactions are submitted to the acquirer transaction processor 40 for clearing.

In a step 506, the merchant server 100 stores transaction data of the processed customer transactions on the merchant database 160 for subsequent communication to the payment network 50 for clearing of the processed customer transactions. The transaction data of the processed customer transactions are stored on the merchant database 160 as EDCs. All EDCs in a predefined period are then lumped together in a batch until the merchant initiates a batch processing stage, which usually occurs at predefined intervals or at a fixed predefined time daily.

In a step 508, the merchant server 100 determines if the customers of the processed customer transactions are eligible for rebates based on past customer transactions performed by the customers with the merchant. The step 508 may include automatically identifying the eligible customers if transaction data of the past customer transactions satisfy predefined eligibility conditions. If the transaction data of the past customer transactions do not satisfy the predefined eligibility conditions, the step 508 proceeds to a step 510 wherein one or more of the customers are determined to be not eligible for rebates. However, the merchant CRM software may allow the merchant to have the discretion to bypass this determination and consider one or more of these ineligible customers to be eligible for rebates. Conversely, if the transaction data of the past customer transactions satisfy the predefined eligibility conditions, the step 508 proceeds to a step 512 wherein the merchant server 100 identifies the processed customer transactions that are performed by the eligible customers. Notably, the identified customer transactions are those that were processed in the step 502.

In a step 514, the merchant server 100 selects one or more of the identified customer transactions for rebating the eligible customers thereof. In one embodiment, the one or more identified customer transactions are automatically selected if the transaction data of the past customer transactions performed by the eligible customers satisfy predefined selection conditions. If the predefined selection conditions are not satisfied, the step 514 proceeds to a step 516 wherein one or more of the identified customer transactions are not selected. However, the merchant CRM software may allow the merchant to have the discretion to bypass this and still select one or more of the identified customer transactions so that the eligible customers thereof can receive rebates. Conversely, if the predefined selection conditions are satisfied, the step 514 proceeds to a step 518 wherein one or more of the identified customer transactions are selected.

In one embodiment, the one or more identified customer transactions are randomly selected regardless of whether the predefined selection conditions are satisfied, such as in the form of a raffle. In another embodiment, selecting the one or more identified customer transactions is not automatic but instead manually done by the merchant. For example, the merchant server 100 may receive a selection input from the merchant for selecting the identified customer transaction. This may happen if the step 514 does not select a particular identified customer transaction, but the merchant still wishes to rebate the customer of the identified customer transaction, such as due long-standing relationship with the customer.

In a step 520, the merchant server 100 performs a rebate transaction 300 for each selected customer transaction for rebating the eligible customers thereof. Particularly, the rebate transactions 300 are individually and respectively performed for the selected customer transactions. As described above, each rebate transaction 300 includes determining the rebate amount and generating rebate transaction data based on the transaction data and rebate amount associated with the selected customer transaction. In some embodiments, each rebate transaction 300 is performed immediately after the respective customer transaction is processed and before another customer transaction is processed, i.e. multiple rebate transactions 300 are performed individually in real time.

In some other embodiments, all the rebate transactions 300 are performed after all the customer transactions are processed, i.e. the rebate transactions are performed in batch mode. The rebate transaction data of the rebate transactions 300 may be aggregated with the transaction data of the processed customer transactions and collectively communicated to the payment network 50. Specifically, in the step 520, the transaction data of the processed customer transactions are stored on the merchant database 160 for subsequent communication to the payment network 50 for clearing of the processed customer transactions. The step 520 may include storing the rebate transaction data of the rebate transactions 300 on the merchant database 160, specifically together with the transaction data of the processed customer transactions in the same batch of files. The batch of files is subsequently communicated to the payment network 50 for batch processing, such that the rebate transactions 300 and processed customer transactions are cleared and settled in the same batch, after which funds are transferred from the merchant to the eligible customers. From the customer's perspective, each rebate transaction would appear as a credit transaction along with other customer transactions the customer has performed with merchants (which are debit transactions). The rebate transaction would include details such as merchant identifier, date of transaction, and rebate amount.

The method 500 described above involves batch processing wherein multiple customer transactions are sent to the payment network 50 for clearing and settlement in a single batch. This batch processing may also be referred to as dual-message clearing, as the authorization stage and clearing stage are separately performed, resulting in distinct response messages. Dual-message clearing may be applicable if, for example, the customer payment instruments are credit cards. In some embodiments, the customer transactions involve single-message clearing or real-time processing instead. Single-message clearing may be applicable if, for example, the customer transactions are PIN-based transactions.

In single-message clearing, the authorization and clearing stages, as well as the settlement stage, are performed simultaneously. All the transaction data needed to authenticate, authorize, clear, and settle a customer transaction, including debiting the merchant financial account and crediting the customer financial account, are exchanged across the payment network 50 at the time the customer transaction occurs. In other words, the transaction data are exchanged across the payment network 50 in real-time processing.

Advantageously, the methods 400 and 500 described above provide a more automated way for the merchant to identify the eligible customers and rebate them automatically when they perform customer transactions with the merchant. The selection of customers to receive rebates is thus less discretionary and arbitrary, allowing the merchant to more appropriately rebate the eligible customers. Loyal customers who have been frequenting the merchant will be eligible to receive appropriate rebates from the merchant, thereby incentivizing the customers to prefer the merchant to others. Furthermore, the merchant may retain some discretion to incentivize customers even if the merchant server 100 determines them to be ineligible for rebates. For example, the merchant may personally know a customer who have been visiting the merchant occasionally (but perhaps not frequent enough to satisfy the predefined eligibility conditions) and the merchant may want to provide the customer with a token of appreciation in the form of a rebate in view of the merchant's relationship with the customer.

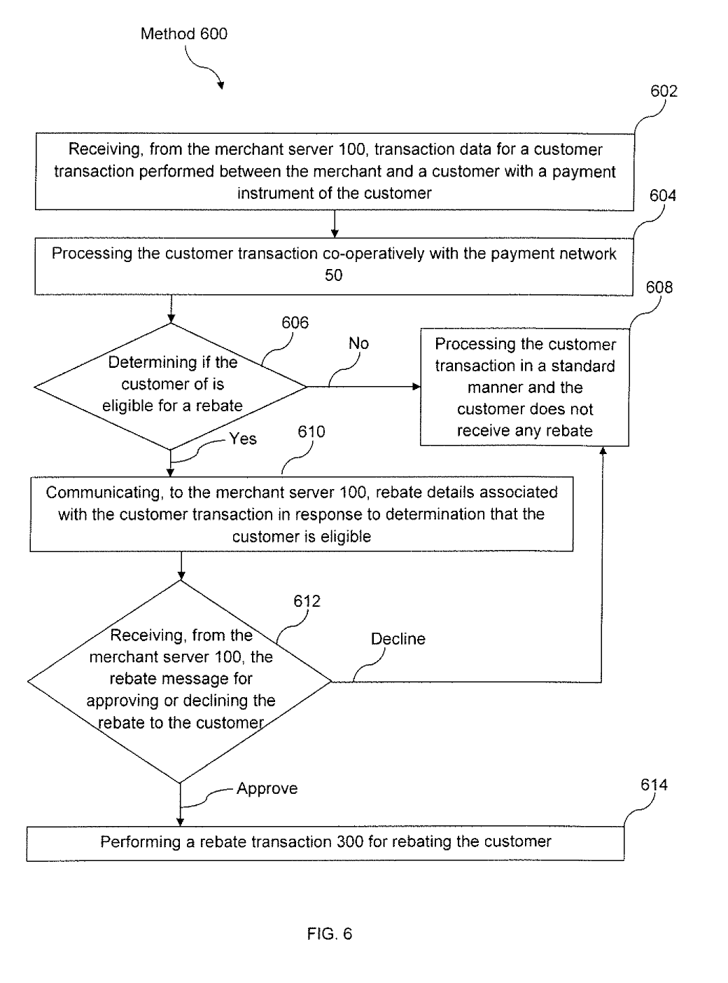

In various embodiments according to another aspect of the present disclosure, some merchants may not have the resources to implement the method 200/300/400 on their merchant servers 100. Instead, the intermediary transaction processing entity 20A may offer the merchants a service that enables the merchants to identify and rebate customers. With reference to FIG. 6, there is shown a computer-implemented or computerized method 600 implemented on the intermediary transaction processor 20. Briefly, the method 600 involves a customer performing a transaction with the merchant, and the rebate transaction 300 is performed after the customer transaction is processed. For purpose of brevity, various aspects of the method 600 are analogous to that of the method 200/400/500 and are omitted in the following description of the method 600.

In a step 602 of the method 600, the intermediary transaction processor 20 receives, from the merchant server 100, transaction data for a customer transaction performed between the merchant and the customer with a payment instrument of the customer. In a step 604, the intermediary transaction processor 20 processes the customer transaction co-operatively with the payment network 50. In a step 606, the intermediary transaction processor 20 determines if the customer is eligible for a rebate based on past customer transactions performed by the customer with the merchant. The step 606 may include automatically identifying the customer as eligible if transaction data of the past customer transactions satisfy the predefined eligibility conditions.

In response to determination that the customer is ineligible, the step 606 proceeds to a step 608 of processing the customer transaction in a standard manner and the customer does not receive any rebate. Conversely, the step 606 proceeds to a step 610 of communicating, to the merchant server 100, rebate details associated with the customer transaction in response to determination that the customer is eligible. The rebate details may include a rebate amount for the customer which may be automatically determined based on the transaction data of the past customer transactions.

Upon receiving the rebate details, the merchant may view the rebate details using the merchant CRM software. As the rebate details are communicated to the merchant server 100 shortly after the customer transaction is performed, the merchant would be able to associate the rebate details with the customer transaction and the particular customer. The rebate details inform the merchant that the customer is eligible for a rebate as well as the rebate amount. The merchant has to decide whether to rebate the customer. The merchant makes a selection using the merchant CRM software generates a rebate message. In a step 612, the intermediary transaction processor 20 receives, from the merchant server 100, the rebate message for approving or declining the rebate to the customer. In some embodiments, the rebate message may include an arbitrary rebate amount that is input by the merchant to override the automatically determined rebate amount.

If the rebate message represents a declination of the rebate to the customer, the step 612 proceeds to the step 608. Conversely, if the rebate message represents an approval of the rebate to the customer, the step 612 proceeds to the 614 of performing a rebate transaction 300 for rebating the customer. The rebate transaction 300 is performed immediately after the customer transaction and before another customer transaction is processed. The rebate transaction 300 includes generating rebate transaction data based on the transaction data and rebate details associated with the customer transaction, and processing the rebate transaction 300 co-operatively with the payment network 50 based on the rebate transaction data. The rebate amount is transferred from a financial account of the merchant to the customer payment instrument after the rebate transaction is processed.

### Technical Architecture

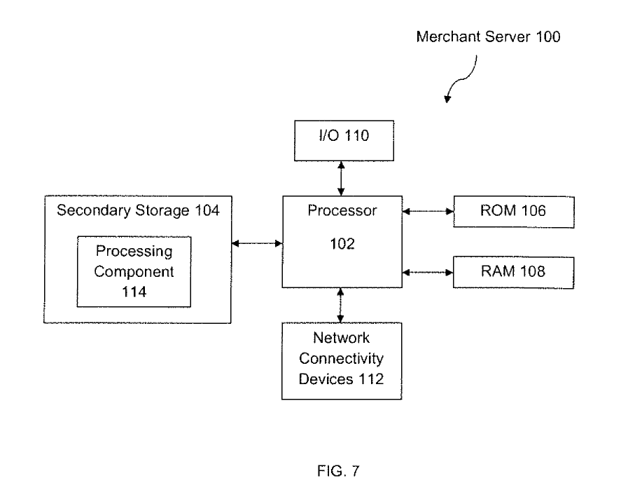

The following is a description of the technical architecture of the merchant server 100 with reference to FIG. 7. It will be appreciated that each of the intermediary transaction processor 20, issuer transaction processor 30, and acquirer transaction processor 40 may have similar technical architecture.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 200/400/500 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 200/400/500 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 200/400/500. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic rebate system and method are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for a merchant to rebate customers, the system comprising a merchant server communicatively linked to a payment network, the merchant server configured for performing steps comprising:
processing a number of customer transactions co-operatively with the payment network, each customer transaction performed between the merchant and a customer with a payment instrument of the customer;
storing transaction data of the processed customer transactions on a merchant database;
determining if the customers of the processed customer transactions are eligible for rebates based on past customer transactions performed by the customers with the merchant;
identifying the processed customer transactions that are performed by the eligible customers;
selecting one or more of the identified customer transactions; and
performing a rebate transaction for each selected customer transaction for rebating the eligible customers thereof.

2. The system according to claim 1, each rebate transaction comprising steps of:
determining a rebate amount for the eligible customer of the selected customer transaction; and
generating rebate transaction data based on the transaction data and rebate amount associated with the selected customer transaction,
wherein the rebate transaction data is communicable to the payment network for processing the rebate transaction.

3. The system according to claim 2, the steps further comprising communicating the rebate transaction data of the rebate transactions to the payment network, wherein the rebate amounts are transferred from a financial account of the merchant to the customer payment instruments for the selected customer transactions after the rebate transactions are processed.

4. The system according to claim 2, wherein each rebate transaction is performed after the respective customer transaction is processed and before another customer transaction is processed.

5. The system according to claim 2, wherein all the rebate transactions are performed after all the customer transactions are processed.

6. The system according to claim 5, wherein the rebate transaction data of all the rebate transactions are aggregated with the transaction data of all the processed customer transactions and collectively communicated to the payment network.

7. The system according to claim 1, wherein the step of determining eligible customers comprises automatically identifying the eligible customers if transaction data of the past customer transactions satisfy predefined eligibility conditions.

8. The system according to claim 7, wherein an identified customer transaction is automatically selected if the transaction data of the past customer transactions performed by the eligible customer of the identified customer transaction satisfy predefined selection conditions.

9. The system according to claim 8, wherein each of the predefined eligibility conditions and predefined selection conditions relate to frequency of transactions with the merchant and/or aggregated transaction expenditure with the merchant.

10. The system according to claim 1, wherein the step of selecting identified customer transactions comprises receiving a selection input from the merchant for selecting the one or more identified customer transactions.

11. The system according to claim 2, wherein for each rebate transaction, the rebate amount is automatically determined based on transaction data of the past customer transactions performed by the eligible customer.

12. The system according to claim 2, wherein each rebate transaction further comprises a step of receiving a rebate input from the merchant for determining the rebate amount.

13. A computerized method for a merchant to rebate customers comprising:
processing, by a merchant server, a number of customer transactions co-operatively with the payment network, each customer transaction performed between the merchant and a customer with a payment instrument of the customer;
storing, by the merchant server, transaction data of the processed customer transactions on a merchant database;
determining, by the merchant server, if the customers of the processed customer transactions are eligible for rebates based on past customer transactions performed by the customers with the merchant;
identifying, by the merchant server, the processed customer transactions that are performed by the eligible customers;
selecting, by the merchant server, one or more of the identified customer transactions; and
performing, by the merchant server, a rebate transaction for each selected customer transaction for rebating the eligible customers thereof.

14. An electronic system for a merchant to rebate customers, the system comprising an intermediary transaction processor communicatively linked to a payment network, the intermediary transaction processor configured for performing steps comprising:
receiving, from a merchant server, transaction data for a customer transaction performed between the merchant and a customer with a payment instrument of the customer;
processing the customer transaction co-operatively with the payment network;
determining if the customer is eligible for a rebate based on past customer transactions performed by the customer with the merchant;
communicating, to the merchant server, rebate details associated with the customer transaction in response to determination that the customer is eligible;
receiving, from the merchant server, a rebate message for approving or declining the rebate to the customer; and
performing a rebate transaction for rebating the customer if the rebate message represents an approval of the rebate to the customer.

15. The system according to claim 14, wherein performing the rebate transaction comprises:
generating rebate transaction data based on the transaction data and rebate details associated with the customer transaction, the rebate details comprising a rebate amount for the customer; and
processing the rebate transaction co-operatively with the payment network based on the rebate transaction data.

16. The system according to claim 15, wherein the rebate amount is transferred from a financial account of the merchant to the customer payment instrument after the rebate transaction is processed.

17. The system according to claim 15, wherein the rebate transaction is performed before another customer transaction is processed.

18. The system according to claim 14, wherein determining if the customer is eligible comprises automatically identifying the customer as eligible if transaction data of the past customer transactions satisfy predefined eligibility conditions.

19. The system according to claim 14, wherein the rebate amount is automatically determined based on transaction data of the past customer transactions performed by the customer.

20. A computerized method for a merchant to rebate customers comprising:
receiving, by an intermediary transaction processor, from a merchant server, transaction data for a customer transaction performed between the merchant and a customer with a payment instrument of the customer;
processing, by the intermediary transaction processor, the customer transaction co-operatively with the payment network;
determining, by an intermediary transaction processor, if the customer is eligible for a rebate based on past customer transactions performed by the customer with the merchant;
communicating, by an intermediary transaction processor, to the merchant server, rebate details associated with the customer transaction in response to determination that the customer is eligible;
receiving, by an intermediary transaction processor, from the merchant server, a rebate message for approving or declining the rebate to the customer; and
performing, by an intermediary transaction processor, a rebate transaction for rebating the customer if the rebate message represents an approval of the rebate to the customer.
